(19) United States
(12) Patent Application Publication
(10) Pub. No.: US 2005/0138218 A1
(43) Pub. Date: Jun. 23, 2005

(54) Portable storage device and its method to display remaining storage capacity

(76) Inventor: Pao-Jean Chen, Taipei (TW)

Correspondence Address: BIRCH STEWART KOLASCH & BIRCH, PO BOX 747, FALLS CHURCH, VA, 22040-0747, US

(21) Appl. No.: 10/740,463

(22) Filed: Dec. 22, 2003

(51) Int. Cl. G06F 3/00

(52) U.S. Cl. 710/1

(57) ABSTRACT

A portable storage device and its method to display remaining storage capacity, its method includes the portable storage device receives data from the computer, stores data in the data storage module of the portable storage device, and retrieves the remaining data storage capacity of the portable storage device from the computer, and stores the remaining data storage capacity in the remaining data storage capacity module in the portable storage device. After receiving the display remaining storage capacity signal, access the remaining data storage capacity form the remaining data storage capacity module and displays the remaining data storage capacity using the display module of the portable storage device.

### BACKGROUND OF THE INVENTION

1. Field of Invention

The present invention relates to a method of displaying the remaining storage capacity, applicable to a portable storage device, especially related to a portable storage device that is able to display the remaining storage capacity.

2. Related Art

Due to the demand of current work or daily life, there is a need to store data or transmit data. The most used method is to use electronic mail with attachments, or use a floppy disk, portable hard drive, removable drive, for data storage and transmission. The electronic mail with an attachment method has limitation for the size of the attachment file, the data capacity of the floppy disk is too small, and the removable hard drive is hard to carry. Therefore, when considering portability and large data storage capacity, the most used method is using portable drives. Since portable drives use universal serial bus (USB), it has the advantage of plug and play. It is also easy to carry, and has a large data storage capacity. There are many types of portable drives in the market, so portable drives with additional functions are being developed; for example, a portable driver with MP3 playing function, or portable drives also used as key chains. However, current users cannot obtain the remaining storage capacity data of the portable drive at any time. If the user wants to find out the capacity of the portable drive, he needs to connect the portable drive to the computer system, and find out the capacity of the portable drive from the computer screen, which is inconvenient.

### SUMMARY OF THE INVENTION

According to the above description, the invention provides a method to display the remaining storage capacity, applicable to a portable storage device. This method allows the user to find out the remaining storage capacity of the portable-storage device without using the computer, and increases the functionality of the portable device.

The invention provides a method to display the remaining storage capacity of the portable storage device. Its method comprises of: Storing data in the data storage module of the portable storage device after the portable storage device has received the data from the computer. Then retrieves the remaining data storage capacity of the portable storage device from the computer and stores the remaining data storage capacity in the remaining data storage capacity module of the portable storage device. After receiving the display remaining storage capacity signal, it accesses the remaining data storage capacity from the remaining data storage capacity module, and displays the data using the display module of the portable storage device.

The invention provides a portable storage device and its method of displaying the remaining storage capacity. The device comprises of: an USB module, used to connect with the computer to transmit data; a data storage module, used to store the transmitted data from the computer; a remaining data storage capacity module used to store the retrieved remaining data storage capacity of the portable storage device; a display module used to display the remaining data storage capacity; a control module using the USB module to receive the transmitted data from the computer and store the data in a data storage module and receiving the display signal from the display key module and displaying the remaining data storage capacity; and a power module providing the described modules power.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given here in below illustration only, and thus is not limitative of the present invention, wherein:

FIG. 1 illustrates the main structure of the portable storage device of the invention.

FIG. 2 illustrates the flow of the method to display the remaining storage capacity of portable storage device and its structure.

FIG. 3 illustrates the operating flow of the portable storage device displaying remaining storage capacity.

### DETAILED DESCRIPTION OF THE INVENTION

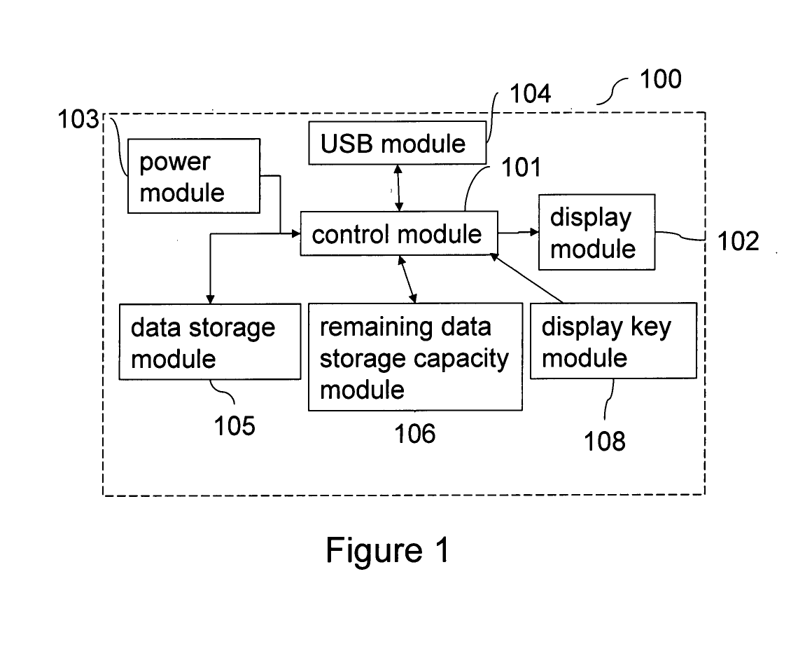

FIG. 1 illustrates the main structure of the portable storage device of the invention. The portable storage device 100 comprises of a control module 101, a display module 102, a power module 103, a USB module 104, a data storage module 105, a remaining data storage capacity module 106, and a display key module 108. The USB module 104 is used to connect with the main host computer platform for data transmission. The main host computer platform can be either a desktop computer or a notebook computer, or palmtop computer, etc. When the portable storage device 100 and the main host computer platform are connected, the transmitted data from the main computer platform are transmitted to the control module 101 via the USB module 104, and the control module 101 stores the transmitted storage data from the main host computer in the data storage module 105. After the data have been stored, the control module 101 retrieves, from the main host computer platform, the remaining data storage capacity of the data storage module of the portable storage device 100 and stores the remaining data storage capacity in the remaining data storage module 106. The control module 101 then receives the display key signal from the display key module 108, and gets the data storage module's remaining data storage capacity from the remaining data storage capacity module 106, and uses the display module 102 to display the data storage module's remaining storage capacity data. Power module 103 is used to provide the power of all of the described modules.

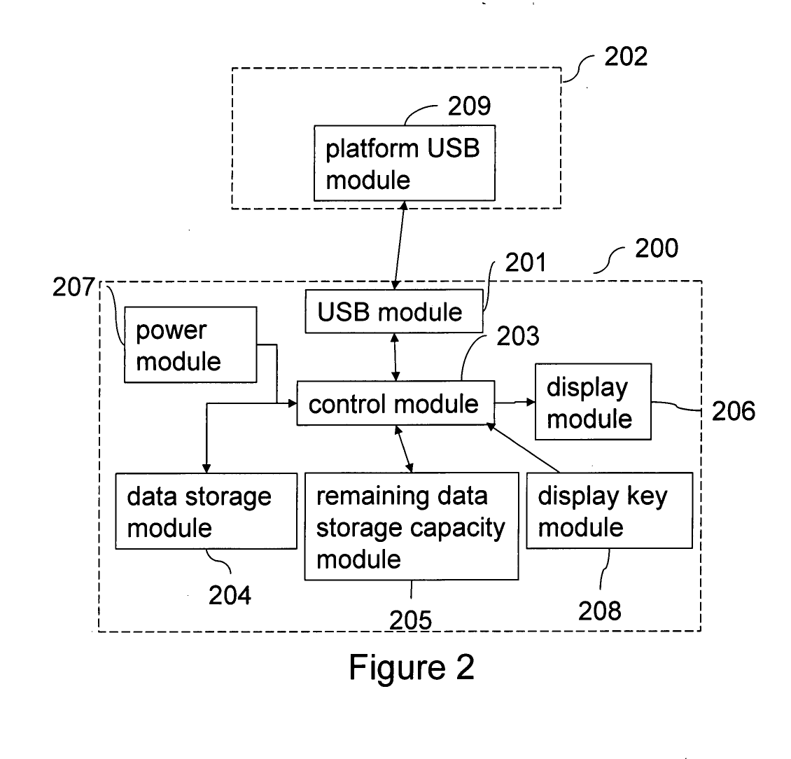

FIG. 2 illustrates the flow of the method to display remaining storage capacity of portable storage device and its structure. At the beginning, a portable storage device 200 can use a USB module 201 to connect with the main host computer platform 202 to transmit data signals. The main host computer platform 202 uses the USB to connect and initialize the storage driving function of the portable storage device 200. After the storage driving function is initialized, the user can use the main host computer platform 202 to transmit the storage data through the USB module of the main host computer and the device's USB module 201 to the portable storage device 200. The control module 203 in the portable storage device 200 then receives the storage data signal, and stores the received storage data into a data storage module 204. When the data storage is completed, the main host computer platform 202 calculates the remaining storage capacity of the data storage module 204, and generates the remaining data storage capacity of the portable storage device 200 in the main host computer platform 202. Now the storage driving function connects the control module 203 to the remaining data storage capacity module 205 in the main host platform 202, using the USB. When the control module 203 in the portable storage device 200 receives the display key signal from the display key module 208, the storage driving function commands the control module to get the remaining data storage capacity of the portable storage device 200 from the remaining data storage capacity module 205. The remaining data storage capacity of portable storage device 200 is transmitted to the display module 206 for display. The power module 207 is used to provide each of the described power modules.

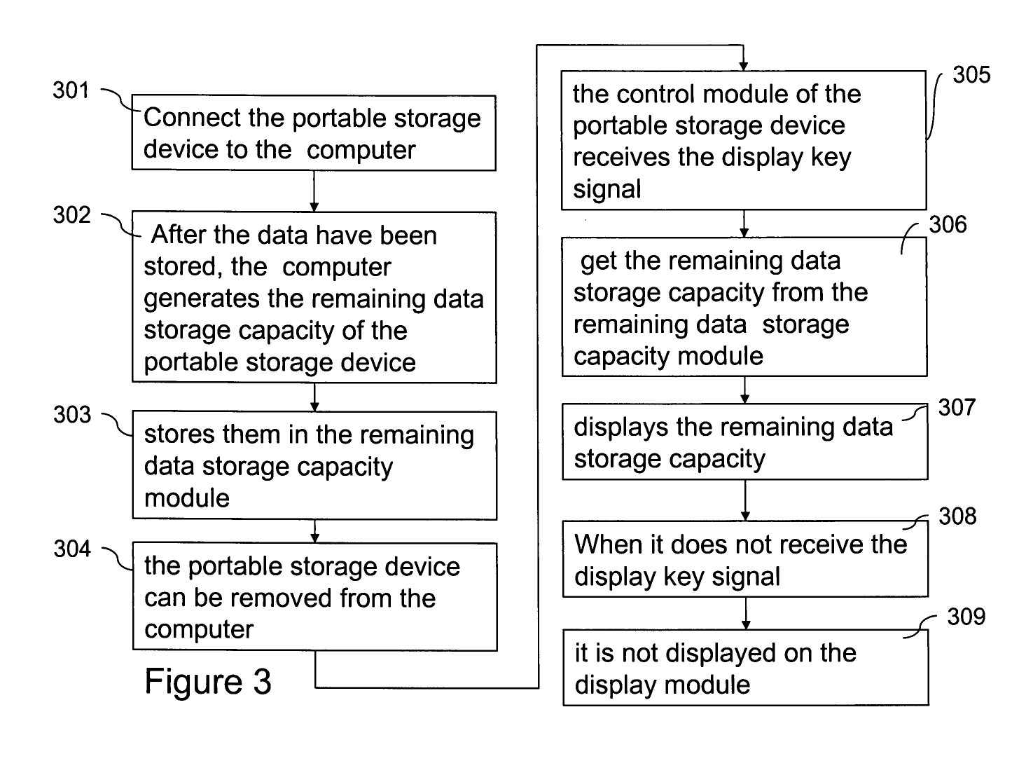

FIG. 3 illustrates the operating flow of the portable storage device displaying the remaining storage capacity. Connect the portable storage device to the computer via USB module (step 301). After the computer is able to store the designated storage data from the computer in the data storage module of the portable storage device, the control unit in the portable storage device stores the received storage data signal in the portable storage device's data storage module. After the data have been stored, the computer calculates the remaining storage capacity of the data storage module 204, and then generates the remaining data storage capacity of the portable storage device (step 302). The storage driving function commands the control module to get the remaining data storage capacity of the portable storage device from the computer, and stores them in the remaining data storage capacity module of the portable storage device (step 303). After the user has completed the operation of storage, the portable storage device can be removed from the computer (step 304). When the control module of the portable storage device receives the display key signal (step 305), the storage driving function commands the control module to get the remaining data storage capacity of the portable storage device from the remaining data storage capacity module (step 306). The display module displays the remaining data storage capacity of the portable storage device (step 307). When it does not receive the display key signal (step 308), the control module does not continue to access the remaining data storage capacity of the portable storage device, so it is not displayed on the display module (step 309).

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method to display remaining storage capacity, applicable to a portable storage device, the method comprises of following steps:
retrieving a remaining data storage capacity about said portable storage device from a main computer host;
storing said remaining data storage capacity in a remaining data storage capacity module in said portable storage device; and
receiving a signal for displaying remaining storage capacity, then accessing said remaining data storage capacity from said remaining data storage module and displaying using a display module of said portable storage device.

2. The method to display remaining storage capacity described in claim 1, wherein said step of retrieving said remaining data storage capacity about said portable storage device from said main computer host also comprises of retrieving said remaining data storage capacity of said portable storage device from a notebook computer and use an USB protocol to transmit said remaining data storage capacity to said portable storage device.

3. The method to display remaining storage capacity described in claim 1, wherein said step of retrieving said remaining data storage capacity about said portable storage device from said main computer host also comprises of retrieving said remaining data storage capacity of said portable storage device from a desktop computer and use USB protocol to transmit said remaining data storage capacity to said portable storage device.

4. The method to display remaining storage capacity described in claim 1, wherein said step of retrieving said remaining data storage capacity about said portable storage device from said main computer host also comprises of retrieving said remaining data storage capacity of said portable storage device from a palmtop computer and use USB protocol to transmit said remaining data storage capacity to said portable storage device.

5. A portable storage device, said portable storage device comprises of a display module to display a remaining data storage capacity, said device comprises of:
an USB module, used to connect to a main host computer to transmit data;
a control module, used to receive said main host computer's transmitted data, and store transmitted data in a data storage module in said portable storage device, and used to store said remaining data storage capacity in a remaining data storage capacity module in said portable storage device, also, after receiving display remaining storage capacity signal, control said display module of said portable storage device to display said remaining data storage capacity; and
a display key module, used to produce said display remaining storage capacity signal to said control module after receiving user's display remaining storage capacity key command.

6. The portable storage device as described in claim 5, wherein comprises of a power module used to provide power to said control module, said data storage module, said remaining data storage capacity module, said USB module, said display key module and said display module.

7. The portable storage device as described in claim 5, wherein said display module comprises a liquid crystal display screen.

8. The portable storage device as described in claim 5, wherein said main host computer is a notebook computer.

9. The portable storage device as described in claim 5, wherein said main host computer is a desktop computer.

10. The portable storage device as described in claim 5, wherein said main host computer is a palmtop computer.
